(19) United States
(12) Patent Application Publication
(10) Pub. No.: US 2008/0144309 A1
(43) Pub. Date: Jun. 19, 2008

(54) Lighted cooking utensil

(75) Inventors: Adam Nagata, Pasadena, CA (US); Huang Meng-Suen, Kowloon (CN)

Correspondence Address: FITZPATRICK CELLA HARPER & SCINTO, 30 ROCKEFELLER PLAZA, NEW YORK, NY, 10112, US

(73) Assignee: Mr. Christmas Incorporated, New York, NY (US)

(21) Appl. No.: 11/640,367

(22) Filed: Dec. 18, 2006

(51) Int. Cl. B25B 23/18

(52) U.S. Cl. 362/120

(57) ABSTRACT

A cooking utensil is disclosed having a handle, a cooking implement extending from the handle, at least one electric light attached to the handle for illuminating at least a portion of the cooking implement, and power means for providing electric power to the light. In addition, the cooking utensil has either or both an attitude-sensitive switch connecting the light and the power means for turning the light on and off in response to the attitude of the utensil, and an ambient light-sensitive switch connecting the light and the power means for turning the light on and off in response to the level of the ambient light.

### BACKGROUND OF THE INVENTION

### Field of the Invention

This invention relates to a lighted cooking utensil. In particular the cooking utensil has a handle, a cooking implement extending from the handle, at least one electric light attached to the handle for illuminating at least a portion of the cooking implement, and power means for providing electric power to the light. In addition, the cooking utensil has either or both an attitude-sensitive switch connecting the light and the power means for turning the light on and off in response to the attitude of the utensil, and an ambient light-sensitive switch connecting the light and the power means for turning the light on and off in response to the level of the ambient light.

Lighted cooking utensils are known, examples of which may be found in U.S. Pat. Nos. 3,839,793 (Crapio), 5,023,761 (de Lange), 5,964,517 (Adams), 6,675,483 B2 (Bond et al.), and U.S. Pat. No. 7,008,007 B2 (Raichlen). Some configurations, such as those disclosed in U.S. Pat. No. 7,008,007 B2, involve mounting a light source, like a flashlight, to the handle of the cooking utensil. Such a configuration has the drawback that it makes the cooking utensil bulky and difficult to use, particularly if the utensil needs be manipulated, as by being rotated, to many different positions.

Other configurations, like those disclosed in U.S. Pat. Nos. 3,839,793, 5,023,761, and 6,675,483 B2, involve integrating the light source into the handle of the cooking utensil. In such configurations, the light source typically is turned on and off either by sliding a switch between an “on” position and an “off” position or by pressing a button switch that turns the light “on” and “off.” These configurations have the drawback that the user must physically turn the switch on and off. If, for example, the user forgets to turn the light off, the light source remains on and the power source is needlessly drained. Additionally, with these configurations, when using the cooking utensil, the user may accidentally cause the light of the cooking utensil to turn off at an inopportune time. Still further, physically turning the switch on or off may be difficult for the user to accomplish and may require two hands while the utensil is being used for its primary purpose of manipulating food.

In yet another configuration, such as that disclosed in U.S. Pat. No. 5,964,517, the switch activating the light source is pressure sensitive. This type of switch has the drawback that if the user changes his or her grip on the utensil during use, the pressure applied to the switch with the new grip may not be sufficient to activate the light source, rendering the cooking utensil difficult to use.

There exists a need, therefore, for a lighted cooking utensil that is easy to use and that minimizes the risk of needless power source drain. The present invention is directed to solving such problems. The cooking utensil of the present invention allows the light or lights to be turned on or off based on either or both of the attitude of the cooking utensil or the ambient light level during use of the utensil. In this manner, the present invention provides a cooking utensil that is easy to use and can preserve the power source when the cooking utensil is not in use.

### SUMMARY OF THE INVENTION

In one aspect, the present invention is directed to a cooking utensil comprising a handle, a cooking implement extending from the handle, at least one electric light attached to the handle for illuminating at least a portion of the cooking implement, power means for providing electric power to the light, and an attitude-sensitive switch connecting the light and the power means in a circuit for turning the light on and off in response to the attitude of the utensil. The attitude-sensitive switch includes a body, a conductive member movably contained within the body, a first contact protruding into the body, and a second contact protruding into the body. The body is configured and is mounted with the handle such that (a) when the utensil is in a first attitude, the conductive member is not in contact with the first contact and the second contact thereby to open the switch and turn the light off, and (b) when the utensil is in a second attitude, the conductive member is in contact with the first contact and the second contact thereby to close the switch and turn the light on.

In another aspect, the cooking utensil comprises a handle, a cooking implement extending from the handle, at least one electric light attached to the handle, power means for providing electric power to the light, and an ambient light-sensitive switch connecting the light and the power means in a circuit for turning the light on and off in response to the level of ambient light. The ambient light-sensitive switch can be configured such that when ambient light falls below a predetermined threshold, the light is turned on.

These and other aspects of the present invention will be apparent upon consideration of the following detailed description taken in conjunction with the accompanying drawings, in which preferred embodiments of the present invention are described and illustrated.

### DESCRIPTION OF THE DRAWINGS

FIG. 1 is a perspective view of the first embodiment of the present invention.

FIG. 2 is a perspective view of the first embodiment of the present invention held by a user and with the light source turned on.

FIG. 3 is a schematic view illustration of the interior of the handle of the cooking utensil according to the first embodiment of the present invention

FIGS. 4A-4C depict configurations of the altitude-sensitive switch incorporated in the cooking utensil when the utensil is in three different attitudes.

FIG. 5 is a perspective view of a second embodiment of the present invention.

Throughout the figures, like or corresponding reference numerals are used to identify like or corresponding parts.

### DETAILED DESCRIPTION OF THE PRESENT INVENTION

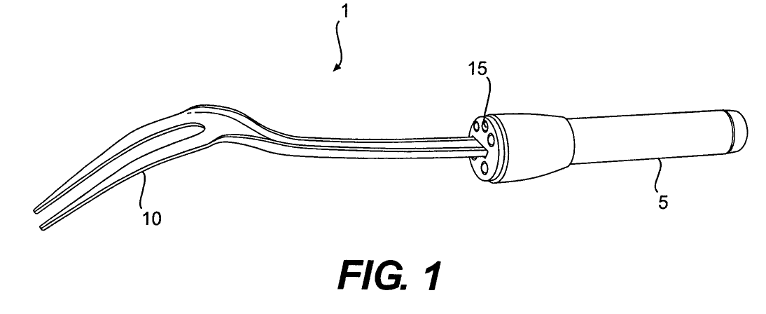

FIG. 1 depicts a lighted cooking utensil 1 according to one embodiment of the present invention. As shown the figure, the cooking utensil 1 has a handle 5 and a cooking implement 10 extending from the handle. In the embodiment depicted in FIG. 1, the cooking implement 10 is a fork, but the invention is not so limited. Other cooking implements may include, for example, a brush, a spatula, a knife, tongs, and the like. The cooking utensil has a number of electric lights 15 in a ring configuration at the end of the handle for at least partially illuminating the cooking implement 10. It is preferred that the lights be focused or aimed directionally at the end of the cooking implement. However, as discussed below, the number, position, and configuration of the lights is not limited to that shown in FIG. 1 and a variety of numbers, positions, and/or configurations of the lights may be used without departing from the scope of the present invention.

The materials used to construct the cooking utensil are not particularly limited. Preferable materials for the handle include hard, durable plastics and metals that are heat resistant. Preferably, the cooking implement is constructed of metal with a coating or cover made of a material that is a heat insulator.

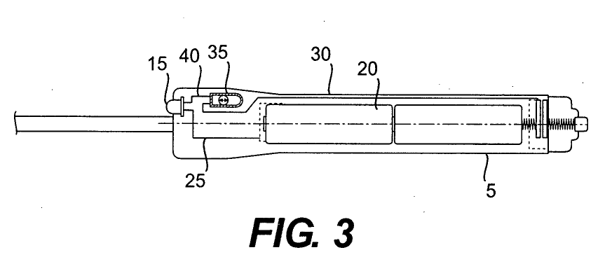

FIG. 3 depicts the interior of the handle 5 according to the one embodiment of the present invention. In that embodiment, the handle is configured to receive a power source 20. The power source 20 may be, for example, a pair of AA size batteries as shown, but the invention is not limited thereto. Other quantities, combinations and types of batteries, such as AAA size batteries, watch-type batteries, and the like may be used without departing from the scope of the present invention. In addition, access to the batteries is shown in FIG. 3 at the rear of the handle 5. However, other configurations for accessing the batteries, for example, at the front of the handle are contemplated. As shown in FIG. 3, a circuit is formed by a wire 25 that connects the power source 20 to the electric lights 15, a second wire 30 that connects the power source to a switch 35, and a third wire 40 that connects the switch 35 to the light 15. Of course, other configurations for connecting the light, power source, and switch may be utilized without departing from the scope of the present invention. The switch 35, depicted in FIG. 3 is an attitude-sensitive switch and is mounted in the handle to extend generally parallel to the handle axis as explained below. As discussed below, the switch 35, according to the present invention, may also take the form of an ambient light-sensitive switch that when closed turns the light on and when opened turns the light off.

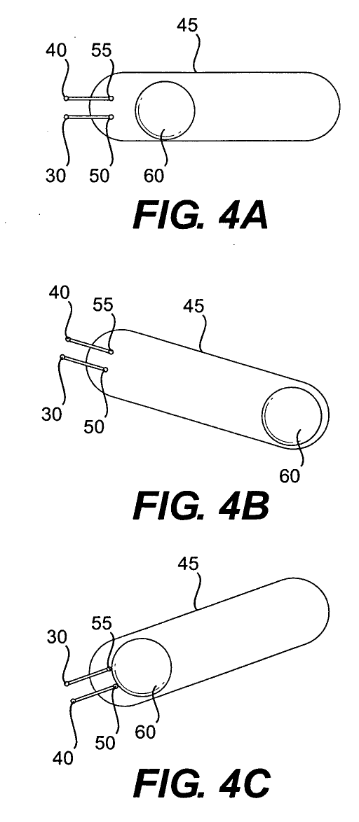

The attitude-sensitive switch, is shown in FIGS. 4A-4C and generally comprises an elongated body 45 mounted in the handle 5 such that its axis extends generally in parallel to the handle axis. The material for the body is not particularly limited, but preferably is glass. Protruding into the body 45, and forming a first contact 50, is lead 30. Also protruding into the body, and forming a second contact 55, is lead 40. Further, movably contained within body 45 is a conductive member 60. Examples of suitable conductive members 60 include a conductive metal ball (shown in FIGS. 4A-4C) and mercury, but the invention is not limited thereto.

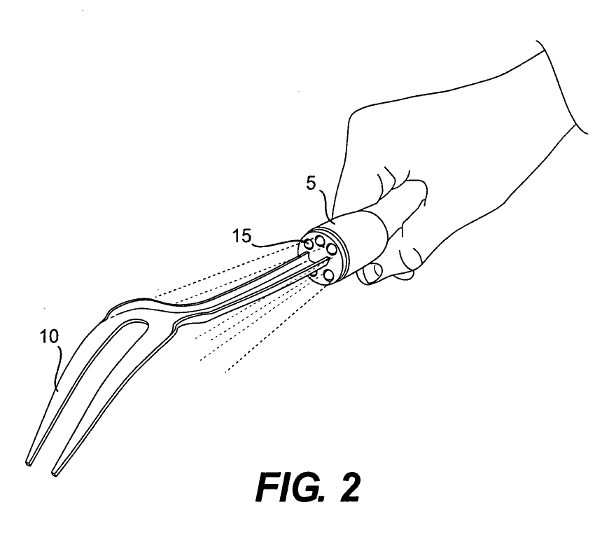

Operation of the attitude-sensitive switch will now be described with reference to FIGS. 4A-4C, it being assumed that the cooking implement is to the left of the switch as seen in those figures. When the body 45 is in a substantially horizontal position, as shown in FIG. 4A, or when the cooking implement is above the handle relative to a cooking work area, as shown in FIG. 4B, the conductive member 60 is not in contact with the first contact 50 and the second contact 55. When the conductive member 60 is not in contact with the first contact 50 and the second contact 55, the circuit remains open and the light 15 is turned off. When, however, the cooking implement is below the handle relative to a cooking work area, as shown in FIG. 2, the conductive member 60 is in contact with the first contact 50 and the second contact 55, and the circuit is thereby closed to turn the light 15 on. FIG. 4C depicts the position of the contact member 60 relative to the first contact 50 and the second contact 55 when the cooking utensil is in the attitude shown in FIG. 2.

The electric light or lights 15 of the present invention are not particularly limited; however, high intensity focused or directionally aimed light emitting diodes (“LEDs”) are preferred. As shown most clearly in FIG. 2, the preferred configuration is for a plurality of lights to be integrated into the handle to form a ring around the area of the handle from which the cooking implement protrudes. The ring configuration is advantageous because lights so positioned can at least partially, and preferably completely, illuminate the area surrounding the cooking implement. In this manner, the amount and position of light can remain relatively constant, even as the cooking utensil is manipulated during use. It should be noted, however, that the number, position and configuration of the lights are not limited to those depicted in FIG. 2. Other numbers, positions and/or configurations of the lights may be used without departing from the scope of the invention. Moreover, in the present invention, the light(s) need not be integrated into the handle. Rather, the lights may instead be attached to the handle, or even integrated in or attached to the cooking implement.

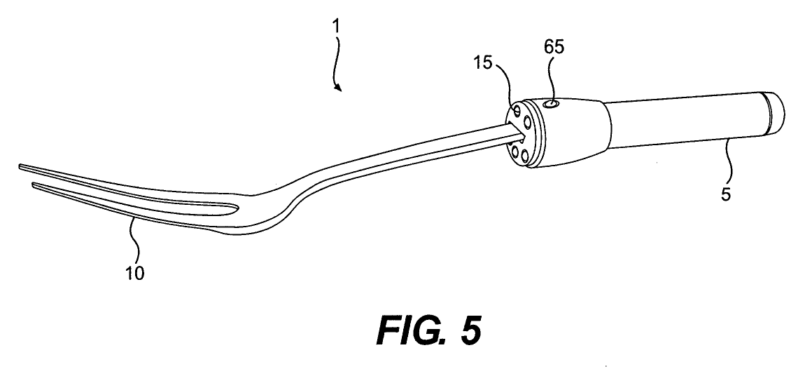

FIG. 5 depicts a second embodiment of the present invention. In this embodiment, an ambient light-sensitive switch 65 has replaced the attitude-sensitive switch of the embodiment depicted in FIG. 1 in the circuit connecting the lights and the power source. In this embodiment, the ambient light-sensitive switch is configured such that when the ambient light level is above a predetermined threshold, the switch 65 is opened and the lights 15 are turned off. When the ambient light level falls below the predetermined threshold, switch 65 is closed and the lights 15 are turned on. In this manner, the lights 15 are turned on only when they are needed in low light conditions, thereby conserving the power source. Again, it should be noted that the power source might be, for example, a battery or a combination of batteries. Suitable batteries include AA batteries, AAA batteries, and watch-type batteries, but the invention is not limited thereto. With the exception of the light switch, the second embodiment of the present invention is similar to the first embodiment, described above.

The ambient light-sensitive switch may be a photodetector that detects the ambient light level and causes the light of the cooking utensil to turn off or on depending on whether the detected ambient light level is above or below the predetermined threshold. The location of the photodetector 65 is not particularly limited. Preferably, however, the photodetector is located in a position such that it is not covered when the user is using the cooking utensil. Also preferably, the photodetector is positioned such that it does not detect an increase in the ambient light level due to the light of the cooking utensil turning on. That is, the photodetector 65 should be positioned in such a manner that it is not influenced by the light(s) of the cooking utensil turning on or off.

It should also be understood that the attitude sensitive switch 35 described with reference to the first embodiment and the ambient light sensitive switch 65 described with reference to the second may both be incorporated in series in the circuit connecting the lights and the power source. In this way, the benefits of the respective embodiments can be provided in a single device.

It is also possible to incorporate a three position, manually operated switch in the circuit shown in FIG. 3 having an “on” position in which case the lights would be turned on at all times, a “tilt on” position in which case the attitude sensitive switch is operable as described above, and an “off” position in which case the lights are always turned off. Similarly, a three position, manually operated switch could be incorporated in the ambient light sensitive second embodiment, with that switch having an “on” position in which case the lights would be turned on at all times, a “photo on” position in which case the ambient light sensitive switch 65 is operable as described above, and an “off” position in which case the lights are always turned off.

Preferred embodiments of the present invention have been described above. However, one of ordinary skill in the art will realize that modifications and variations, including but not limited to those discussed above, are possible within the spirit and scope of the present invention. The invention is intended to be limited in scope only by the accompanying claims, which should be accorded the broadest interpretation so as to encompass all such modifications, equivalent structures and functions.

We claim:

1. A cooking utensil comprising:
a handle;
a cooking implement extending from said handle;
at least one electric light attached to said handle;
power means for providing electric power to said light; and
an attitude-sensitive switch connecting said light and said power means for turning said light on and off in response to the attitude of said utensil.

2. The cooking utensil according to claim 1, wherein said attitude-sensitive switch comprises:
a body;
a conductive member movably contained within said body;
a first contact protruding into said body; and
a second contact protruding into said body;
said body being configured and being mounted with said handle such that (a) when said utensil is in a first attitude, said conductive member is not in contact with said first contact and said second contact thereby to turn said light off, and (b) when said utensil is in a second attitude, said conductive member is in contact with said first contact and said second contact thereby to turn said light on.

3. The cooking utensil according to claim 2, wherein when said utensil is in the first attitude, said implement is above said handle relative to a cooking work area.

4. The cooking utensil according to claim 2, wherein when said utensil is in the second attitude, said implement is below said handle relative to a cooking work area.

5. The cooking utensil according to claim 2, wherein the body is made of glass.

6. The cooking utensil according to claim 2, wherein said movable conductive member is one of a conductive metal ball and mercury.

7. The cooking utensil according to claim 1, wherein said cooking implement is at least one of a brush, a spatula, a fork, a knife, and tongs.

8. The cooking utensil according to claim 1, wherein said light is positioned and configured to illuminate said cooking implement when turned on.

9. The cooking utensil according to claim 1, wherein said light is a light emitting diode.

10. The cooking utensil according to claim 1, wherein said power means comprises a battery and said handle is configured to receive said battery.

11. A cooking utensil comprising:
a handle;
a cooking implement extending from said handle;
at least one electric light attached to said handle;
power means for providing electric power to said light; and
an ambient light-sensitive switch connecting said light and said power means for turning said light on and off in response to the level of ambient light.

12. The cooking utensil according to claim 11, wherein said ambient light-sensitive switch is configured such that when the ambient light falls below a predetermined threshold, said light is turned on.

13. The cooking utensil according to claim 11, wherein said cooking implement is at least one of a brush, a spatula, a fork, a knife, and tongs.

14. The cooking utensil according to claim 11, wherein said light is positioned and configured when turned on to illuminate said cooking implement.

15. The cooking utensil according to claim 11, wherein said light is a light-emitting diode.

16. The cooking utensil according to claim 11, wherein said power means comprises a battery and said handle is configured to receive said battery.

17. A cooking utensil comprising:
a handle;
a cooking implement extending from said handle;
at least one electric light attached to said handle;
power means for providing electric power to said light;
an attitude-sensitive switch and an ambient light-sensitive switch connecting said light and said power means for turning said light on and off in response to the attitude of said utensil and in response to the level of ambient light.

18. The cooking utensil according to claim 17, wherein said attitude-sensitive switch comprises:
a body;
a conductive member movably contained within said body;
a first contact protruding into said body; and
a second contact protruding into said body;
said body being configured and being mounted with said handle such that (a) when said utensil is in a first attitude, said conductive member is not in contact with said first contact and said second contact thereby to open said attitude-sensitive switch, and (b) when said utensil is in a second attitude, said conductive member is in contact with said first contact and said second contact thereby to close said attitude-sensitive switch.

19. The cooking utensil according to claim 18, wherein when said utensil is in the first attitude, said implement is above said handle relative to a cooking work area.

20. The cooking utensil according to claim 18, wherein when said utensil is in the second attitude, said implement is below said handle relative to a cooking work area.

21. The cooking utensil according to claim 18, wherein the body is made of glass.

22. The cooking utensil according to claim 18, wherein said movable conductive member is one of a conductive metal ball and mercury.

23. The cooking utensil according to claim 17, wherein said cooking implement is at least one of a brush, a spatula, a fork, a knife, and tongs.

24. The cooking utensil according to claim 17, wherein said light is positioned and configured to illuminate said cooking implement when turned on.

25. The cooking utensil according to claim 17, wherein said light is a light emitting diode.

26. The cooking utensil according to claim 17, wherein said power means comprises a battery and said handle is configured to receive said battery.

27. The cooking utensil according to claim 17, wherein said ambient light-sensitive switch is configured such that when the ambient light falls below a predetermined threshold, said ambient light-sensitive switch is closed.
